(19) United States
(12) Patent Application Publication
(10) Pub. No.: US 2008/0062582 A1
(43) Pub. Date: Mar. 13, 2008

(54) Tunnel magnetoresistive element and manufacturing method thereof

(75) Inventor: Kojiro Komagaki, Kawasaki (JP)

Correspondence Address: Patrick G. Burns;GREER, BURNS & CRAIN, LTD., Suite 2500, 300 South Wacker Drive, Chicago, IL, 60606, US

(73) Assignee: FUJITSU LIMITED

(21) Appl. No.: 11/710,692

(22) Filed: Feb. 26, 2007

(30) Foreign Application Priority Data
Sep. 11, 2006 (JP) 2006-244977

(51) Int. Cl. G11B 5/33

(52) U.S. Cl. 360/324.11

(57) ABSTRACT

Stable anti-ferromagnetic exchange coupling can be obtained between a first pinned magnetic layer in a magnetoresistive element and a second pinned magnetic layer through smoothing of a non-magnetic intermediate layer, by smoothing the first pinned magnetic layer. The magnetoresistive element is made by sequentially laminating an underlayer, an anti-ferromagnetic layer, the first pinned magnetic layer, the non-magnetic intermediate layer, the second pinned magnetic layer, a tunnel barrier layer, a free magnetic layer, and a protection layer. The first pinned magnetic layer is smoothed before the non-magnetic intermediate layer is laminated over the first pinned magnetic layer. Stable magnetoresistive characteristics can be obtained, even when thickness is reduced, by smoothing the tunnel barrier layer. In that case, excellent magnetoresistive characteristics can also be obtained even when the tunnel barrier layer requires crystal properties.

The present invention relates to a tunnel magneto-resistive element and a manufacturing method thereof, and more specifically to a film structure of a tunnel magnetoresistive element.

### BACKGROUND OF THE INVENTION

To improve hard disk drives (HDD) to have higher capacity and smaller size, a high sensitivity, high output thin film magnetic head is needed. Even the performance characteristics of a gigantic magnetoresistive (GMR) element must be further improved. To this end, development of a tunnel magnetoresistive (TMR) element, which is expected to provide a resistance changing rate of two times or more the rate of the GMR element, is continuing.

A film structure of a convention tunnel magnetoresistive element is shown in FIG. 1. The tunnel magnetoresistive element has an underlayer 1, an anti-ferromagnetic layer 2, a first pinned magnetic layer 3 pinned with an exchange coupling force from the anti-ferromagnetic layer 2, a non-magnetic layer 4, a second pinned magnetic layer 5 for antiferromagnetic exchange coupling with the first pinned layer 3, a tunnel barrier layer 6, a free magnetic layer 7 and a protection layer 8.

In general, since a thinner anti-ferromagnetic layer can be formed easily, anti-ferromagnetic exchange coupling is employed between the first pinned magnetic layer 3 and the second pinned magnetic layer 5 via the non-magnetic intermediate layer 4, shown in FIG. 1. When a magnetoresistive element is used as a magnetic head, the element is formed with an ion milling process using a photoresist as a mask. Accordingly, a cross-section of the element becomes a trapezoidal shape including tapered portions 9, as shown in FIG. 2.

FIG. 2 shows a cross-section of the element viewed from the direction vertical to the surface opposed to a medium. Here, a core width of the magnetic head must be narrowed to realize higher density. Therefore, the width of the core of the magnetic head is different depending on whether the width of the free magnetic layer that defines the core width is located at the area near the upper side of the trapezoidal shape or at the area near the lower side thereof. Conventionally, the anti-ferromagnetic layer 2 is laminated at the lower side of the first pinned magnetic layer 3 so that the free magnetic layer 7 is located at the area near the upper side in order to realize the narrow core width shown in FIG. 2.

Here, the tunnel magnetoresistive element is capable of passing a heavier current and obtaining a larger output voltage by forming the tunnel barrier layer thinner to lower element resistance. Lower element resistance also prevents electrostatic breakdown.

However, the thickness of the tunnel barrier layer is 1 nm or less. When a thinner tunnel barrier layer is formed, smoothness is not assured, and pinholes are produced in parts of the tunnel barrier layer. When a sense current flows through the pinholes, high output can no longer be obtained. Accordingly, a thinner tunnel barrier layer must be formed to obtain a higher output, but smoothness of the tunnel barrier layer is important to realize such higher output and thinner tunnel barrier layer.

To address this situation, the second pinned magnetic layer 5 has been smoothed by inverse sputtering before formation of the tunnel barrier layer, and smoothness of the tunnel barrier layer itself has been realized by laminating the tunnel barrier layer on such smooth magnetic layer. That is, an excellent smooth surface can be obtained even on the tunnel barrier layer by making the surface of the underlayer of the tunnel barrier layer smooth.

An Al₂O₃ layer is generally used as the tunnel barrier layer of the tunnel magnetoresistive element, but a MgO layer can also be used as the barrier layer, to obtain a higher magnetoresistive characteristic. The Al₂O₃ layer is an amorphous layer but the MgO layer is a crystal layer. A crystal structure of the layer is very important to obtain excellent tunnel magnetoresistive effect. To obtain an excellent tunnel magnetoresistive effect using the MgO layer, though, the second pinned magnetic layer which is used as the underlayer of the MgO layer must be an amorphous layer.

A narrow gap is required for the gap between the magnetic shields in the magnetic head because of the requirement of high recording density. Since the tunnel magnetoresistive element is held between the magnetic shields, reduction in the thickness of the thick anti-ferromagnetic layer is important even in the tunnel magnetoresistive element, to form the narrow gap. As an ordinary anti-ferromagnetic layer, a Pt—Mn alloy showing large exchange coupling force and high blocking temperature is used. However, the layer used as the anti-ferromagnetic layer is comparatively thick, e.g., 10 to 20 nm. On the other hand, when the layer is formed of Ir—Mn alloy, it may be used even when it has the thickness of about 5 to 10 nm. Accordingly, when the narrow gap is considered here, the Ir—Mn alloy has higher potential as the anti-ferromagnetic layer. However, it is known that the surface of the Ir—Mn alloy is rougher than that of the Pt—Mn alloy.

FIG. 6 shows a relationship between TMR ratio (%) and RA (Ωμm²) when the second pinned magnetic layer is inversely sputtered. The film structure of the tunnel magnetoresistive film used for the experiment was constituted with a Ta under layer of 5 nm thickness, Ru under layer of 2 nm thickness, an IrMn anti-ferromagnetic layer of 10 nm thickness, a CoFe first pinned layer of 2.5 nm thickness, a Ru non-magnetic layer of 0.8 nm thickness, a CoFeB second pinned layer of 3 nm thickness, a MgO tunnel barrier layer of 1 nm thickness, a CoFeB free layer of 3 nm thickness, a Ta protection layer of 5 nm thickness, and an Ru protection layer of 10 nm thickness. Inverse sputtering was conducted within a vacuum chamber under the atmosphere of Ar gas of 10⁻² Pa. When the MgO layer is used as the tunnel barrier layer as explained above, orientation of MgO is impeded. If the second pinned magnetic layer is smoothed by inverse sputtering or the like as in the case of the related art, orientation of MgO is impeded and excellent magnetoresistive characteristic cannot be obtained. However, when the thickness of the tunnel barrier layer is reduced and the surface roughness of the film is considerable, because the anti-ferromagnetic layer is used, or particularly the Ir—Mn alloy is used as the anti-ferromagnetic layer, the smoothing process is essential.

Anti-ferromagnetic exchange coupling between the first pinned magnetic layer and the second pinned magnetic layer largely depends on the thickness of the non-magnetic intermediate layer held by such first and second pinned magnetic layers. Since thickness of the non-magnetic intermediate layer is only 1 nm or less, when film thickness fluctuates, it is no longer possible to obtain excellent exchange coupling between the first and second pinned magnetic layers. That is, when the Ir—Mn alloy is used as the anti-ferromagnetic layer, roughness in the film surface of the non-magnetic intermediate layer is increased, and excellent exchange coupling cannot be attained.

It is therefore an object of the present invention to provide a tunnel magnetoresistive element and a manufacturing method thereof for realizing reduction in the thickness of layers, to address various problems explained above and obtain excellent magnetoresistive characteristics.

### SUMMARY OF THE INVENTION

In keeping with one aspect of this invention, a magnetoresistive element is formed by sequentially laminating an underlayer, an anti-ferromagnetic layer, a first pinned magnetic layer, a non-magnetic intermediate layer, a second pinned magnetic layer, a tunnel barrier layer, a free magnetic layer and a protection layer. The first pinned magnetic layer is smoothed before the non-magnetic intermediate layer is laminated. Since the first pinned magnetic layer is smoothed, the non-magnetic intermediate layer laminated thereafter is also smooth, and stable antiferromagnetic exchange coupling between the first pinned magnetic layer and the second pinned magnetic layer can be obtained. Moreover, the tunnel barrier layer laminated thereon is also smoothed, so that thickness can be reduced without generation of one or more pinholes.

Smoothing is conducted so that the average roughness Ra of the center line is 0.3 nm or less. When the average roughness Ra of the center line is 0.3 nm or less, the smooth surface is comparable to that when the Pt—Mn alloy, for example, is used as the anti-ferromagnetic layer and therefore excellent magnetoresistive characteristics can be obtained.

Moreover, the anti-ferromagnetic layer is preferably formed of an Ir—Mn alloy. When the Ir—Mn alloy is used as the anti-ferromagnetic layer, smoothness of the film surface after formation thereof is poor in comparison with that when the Pt—Mn alloy, for example, is used. Moreover, stable anti-ferromagnetic exchange coupling between the first and second pinned magnetic layers cannot be obtained even when the non-magnetic intermediate layer is laminated on the film. However, stable anti-ferromagnetic exchange coupling between the first and second pinned magnetic layers can be attained by smoothing the first pinned magnetic layer. In addition, when the Ir—Mn alloy is used as the anti-ferromagnetic layer, smoothing of the tunnel barrier layer can provide a significant improvement in performance.

The tunnel barrier layer is preferably formed of a MgO layer. When the MgO layer is used as the tunnel barrier layer, another smoothing process is required, because its crystal structure has a large influence on the magnetoresistive characteristics. However, when the second pinned magnetic layer is smoothed, the excellent crystal structure of MgO cannot be obtained. Accordingly, excellent crystal structure of MgO can be obtained by smoothing the first pinned magnetic layer.

The manufacturing method of the magnetoresistive element is performed by sequentially laminating an underlayer, an anti-ferromagnetic layer, a first pinned magnetic layer, a non-magnetic intermediate layer, a second pinned magnetic layer, a tunnel barrier layer, a free magnetic layer, and a protection layer, and by smoothing the first pinned magnetic layer before lamination of the non-magnetic intermediate layer. The magnetoresistive element explained above can be obtained with the manufacturing method.

The first pinned magnetic layer can be laminated again before lamination of the non-magnetic intermediate layer after the smoothing process. In other words, the thickness of the first pinned magnetic layer is reduced from the required thickness and is then increased up to the required thickness by forming the first pinned magnetic layer again.

The smoothing process of the first pinned magnetic layer can be conducted with a gas cluster ion beam or inverse sputtering process. As the smoothing means, the gas cluster ion beam or inverse sputtering process, which can be conducted in the identical vacuum condition, is employed to prevent deterioration of film characteristics.

An Ir—Mn alloy can be used as the anti-ferromagnetic layer, while the MgO layer can be used as the tunnel barrier layer. Under the conditions explained above, the present invention can provide improved performance.

The magnetoresistive element and manufacturing method thereof in the present invention can provide a magnetoresistive element which has excellent anti-ferromagnetic exchange coupling between the first and second pinned magnetic layers, realizes reduction in thickness of the tunnel barrier layer and obtains higher magnetic resistance.

### BRIEF DESCRIPTION OF THE DRAWINGS

The present invention will be explained with reference to the accompanying drawings.

FIG. 1 is a cross-sectional view of a film structure of a conventional tunnel magnetoresistive element.

FIG. 2 is a cross-sectional view of a tapered shape of the magnetoresistive element of FIG. 1.

FIGS. 3(a)-3(d) are diagrams showing the magnetoresistive element and manufacturing method thereof in the first embodiment of the present invention.

FIGS. 4(a)-4(e) are diagrams showing the magnetoresistive element and manufacturing method thereof in the second embodiment of the present invention.

FIG. 5 is a diagram showing a relationship among the inverse sputtering time, TMR ratio (%), and RA (Ωμm²) of the first pinned magnetic layer in the present invention.

FIG. 6 is a diagram showing a relationship between the TMR ratio (%) and the RA (Ωμm²) when the second pinned magnetic layer in the related art is re-sputtered.

FIG. 7(a) is a diagram of a disk drive having the magnetoresistive element of the present invention, and FIG. 7(b) is a diagram of a head slider having the magnetoresistive element of the present invention.

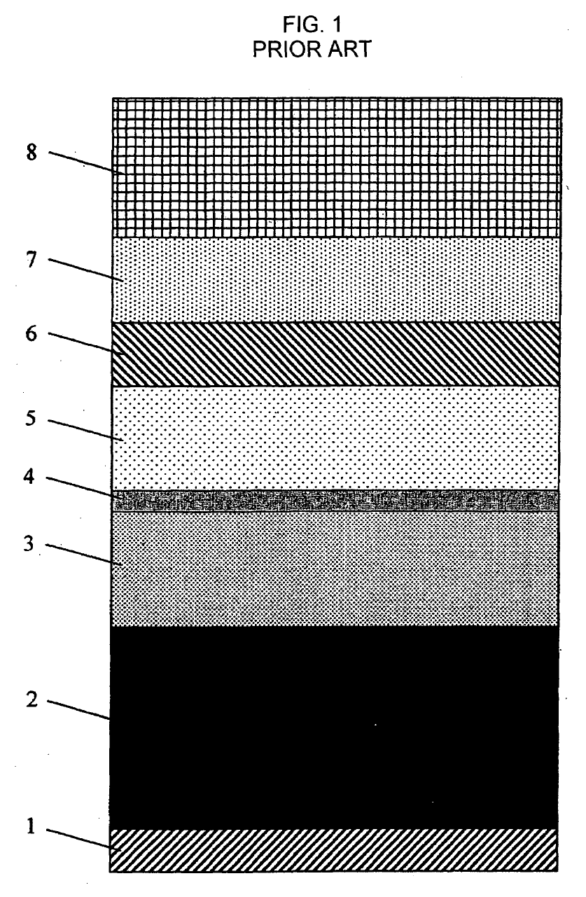

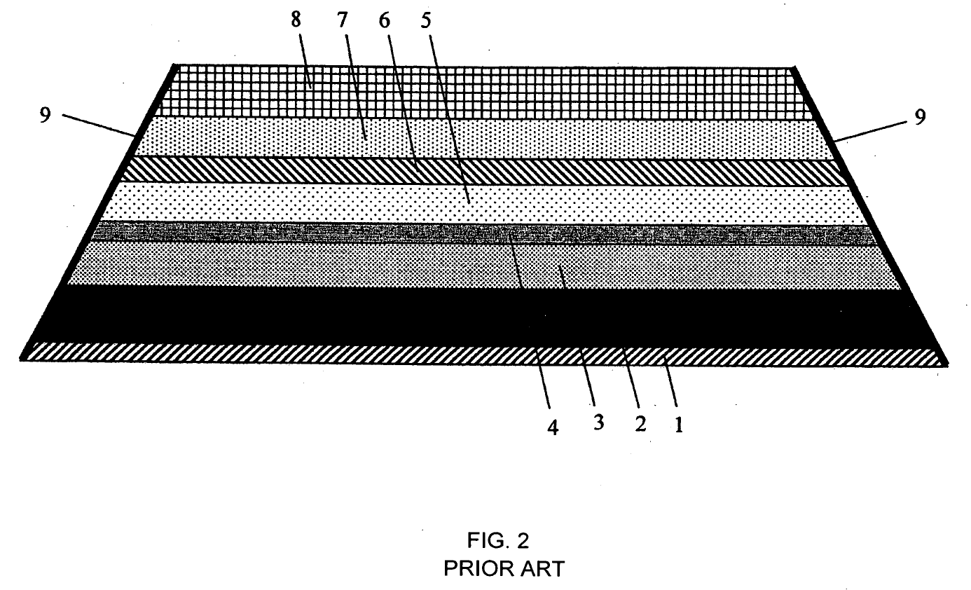

### DETAILED DESCRIPTION

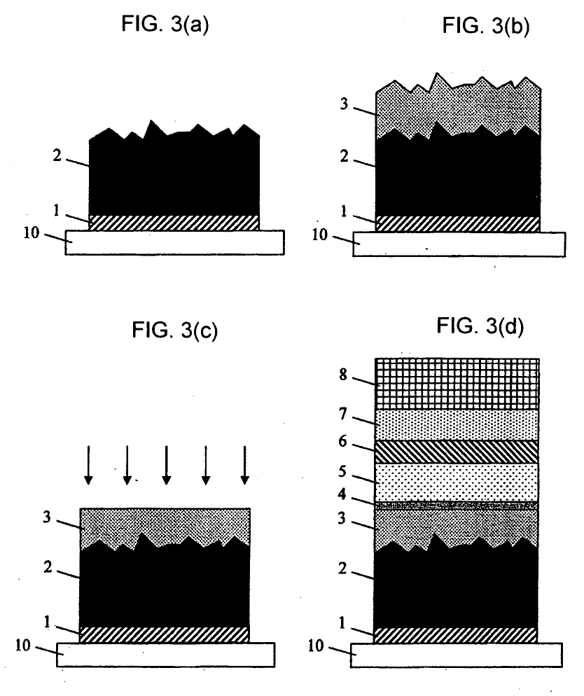

FIGS. 3(a)-3(d) show the first embodiment of a method of manufacturing magnetoresistive elements of the present invention. FIGS. 3(a)-3(d) are cross-sectional views of the magnetoresistive element. As shown in FIG. 3(a), an underlayer 1 of Ta is formed on a substrate 10 made of Al₂O₃—TiC, and an anti-ferromagnetic layer 2 of Ir—Mn alloy is formed subsequently. Here, the anti-ferromagnetic layer 2 has surface roughness higher than that of the anti-ferromagnetic layer made of Pt—Mn alloy which is generally used. Accordingly, as shown in FIG. 3(b), the first pinned magnetic layer laminated on the Ir—Mn alloy also has higher surface roughness because of the influence of the Ir—Mn alloy as the underlayer.

Thereafter, the surface of the first pinned magnetic layer is smoothed with the gas cluster ion beam or inverse sputtering method as shown in FIG. 3(c). Next, as shown in FIG. 3(d), a non-magnetic intermediate layer 4 of Ru, a second pinned magnetic layer 5 of Co—Fe alloy, a tunnel barrier layer 6 of MgO, a free magnetic layer 7 of Co—Fe alloy, and a protection layer 8 of Ta are continuously laminated with the sputtering method on the smoothed first pinned magnetic layer 3. Here, it is more desirable that the first pinned magnetic layer 3 be formed with sufficiently larger thickness than the predetermined thickness in order to obtain excellent magnetoresistive characteristics by conducting irradiation of the gas cluster ion beam or inverse sputtering.

When the tunnel magnetoresistive element of the present invention is used in the magnetic head, the tunnel magnetoresistive element is laminated, for example, after an insulating layer made of Al₂O₃ and a shield layer of NiFe are laminated on Al₂O₃—TiC of the substrate. This is also true in the second embodiment.

When Al₂O₃ is used for the tunnel barrier layer, any influence is applied on the magnetoresistive characteristic thereof, even if the second pinned magnetic layer as the underlayer is smoothed with the gas cluster ion beam or inverse sputtering method, because Al₂O₃ forms an amorphous layer. However, when MgO is used as the tunnel barrier layer, excellent magnetoresistive characteristics cannot be obtained when the second pinned magnetic layer is used as the underlayer and is smoothed with the gas cluster ion beam or inverse sputtering method, because the crystal layer and crystal structure of MgO is important to obtain excellent magnetoresistive characteristics.

However, according to the present invention, since the first pinned magnetic layer is smoothed with the gas cluster ion beam or inverse sputtering method, the MgO layer can be formed continuously as the tunnel barrier layer on the second pinned magnetic layer and thereby obtain excellent magnetoresistive characteristics.

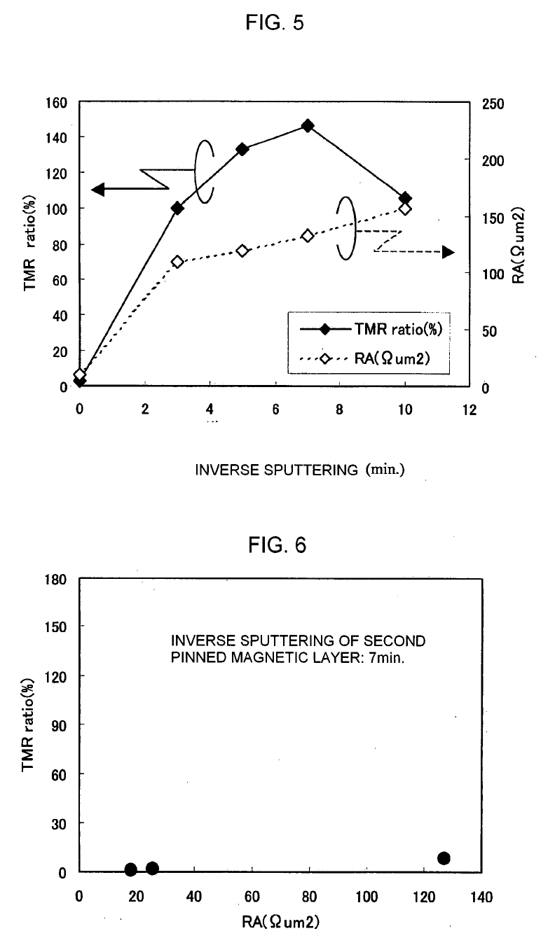

FIG. 5 shows a relationship among the inverse sputtering time of the first pinned magnetic layer, TMR ratio (%) and RA (Ωμm²). The tunnel magnetoresistive film used for the experiment has a structure constituted with a Ta underlayer of 5 nm thickness, an Ru under layer of 2 nm thickness, an IrMn anti-ferromagnetic layer of 10 nm thickness, a CoFe first pinned magnetic layer of 2.5 nm thickness, a non-magnetic layer of Ru of 0.8 nm thickness, a CoFeB a second pinned layer of 3 nm thickness, an MgO tunnel barrier layer of 1 nm thickness, a CoFeB free layer of 3 nm thickness, a Ta protection layer of 5 nm thickness, and an Ru protection layer of 10 nm thickness. The inverse sputtering was conducted within a vacuum chamber under the atmosphere of Ar gas of 10⁻² Pa. The data of inverse sputtering time 0 (min) indicates that when the magnetoresistive element is not subjected to inverse sputtering, excellent magnetoresistive characteristic cannot be obtained.

Moreover, particularly when the Ir—Mn alloy is used as the anti-ferromagnetic layer, surface roughness of the anti-ferromagnetic layer influences the non-magnetic intermediate layer when the anti-ferromagnetic layer, first pinned magnetic layer and non-magnetic intermediate layer are formed continuously. However, according to the present invention, since the Ru non-magnetic intermediate layer is also smoothed, excellent anti-ferromagnetic exchange coupling can be attained between the first pinned magnetic layer and the second pinned magnetic layer.

The magnetoresistive element manufactured as explained above, where the first pinned magnetic layer is smoothed, shows excellent magnetoresistive characteristic.

The anti-ferromagnetic layer and non-magnetic intermediate layer can also be smoothed with inverse sputtering. However, in this case, excellent exchange coupling between the anti-ferromagnetic layer and the first pinned magnetic layer and excellent anti-ferromagnetic exchange coupling between the first pinned magnetic layer and the second pinned magnetic layer cannot be obtained.

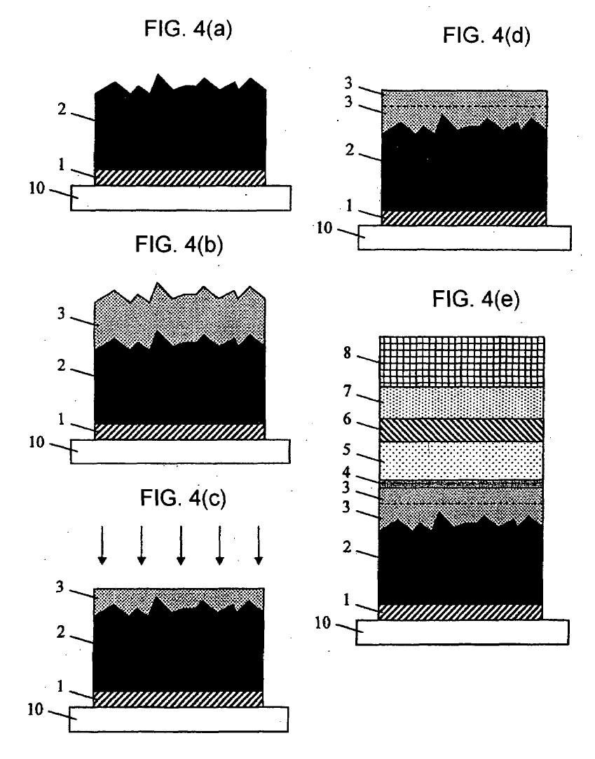

FIGS. 4(a)-4(e) show the second embodiment of the manufacturing method of magnetoresistive element of the present invention. As shown in FIG. 4(a), the Ta underlayer 1 is formed on the Al₂O₃—TiC substrate 10 with the Al₂O₃—TiC anti-ferromagnetic layer 2 formed thereon. Since surface roughness of the anti-ferromagnetic layer 2 is higher, the surface of the first pinned magnetic layer 3 laminated thereon also has higher roughness, as shown in FIG. 4(b). Therefore, as shown in FIG. 4(c), the surface of the first pinned magnetic layer 3 is smoothed with the gas cluster ion beam or inverse sputtering method. The manufacturing method explained above is identical to that of the first embodiment.

The first pinned magnetic layer 3 can be formed with a thickness less than the predetermined thickness by extending the irradiation time of the gas cluster ion beam or the inverse sputtering time required for smoothing the surface of the first pinned magnetic layer 3 with the gas cluster ion beam or inverse sputtering method. The thickness can be increased up to the predetermined thickness by sputtering the first pinned magnetic layer 3 again, as shown in FIG. 4(d), and thereafter the Ru non-magnetic intermediate layer 4, the Co—Fe alloy second pinned magnetic layer 5, the MgO tunnel barrier layer 6, the Co—Fe alloy free magnetic layer 7, and the Ta protection layer 8 are continuously laminated with the sputtering method, as shown in FIG. 4(e). The first pinned magnetic layer can be smoothed sufficiently by extending the irradiation time of the gas cluster ion beam and the inverse sputtering time.

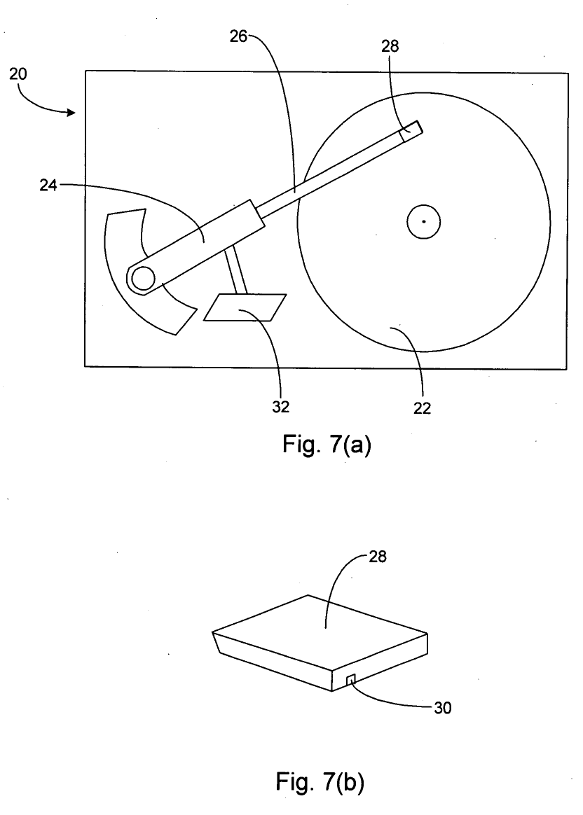

The magnetoresistive element of the present invention can be used in a hard disk drive, an example of which is shown in FIG. 7(a). A hard disk drive 20 includes at least one rotating disk memory medium 22. The disk 22 is rotated by a spindle motor (not shown). An actuator arm 24 operated by voice coil motor or the like, moves a suspension 26 across the disk 22 in a generally radial manner across the disk 22.

A head slider 28 is located at the distal end of the suspension 26, and includes a read/write element 30. The read head in the read/write element 30 is the magnetoresistive element of the present invention. Information recorded on the disk 22 is read by the magnetoresistive element as the disk rotates and the actuator moves the magnetoresistive element across predetermined tracks on the disk. A control system 32 includes controllers, memory, etc. sufficient to control disk rotation, actuator movement and read/write operations, in response to commands from a host (not shown).

While the principles of the invention have been described above in connection with specific apparatus and applications, it is to be understood that this description is made only by way of example and not as a limitation on the scope of the invention.

What is claimed is:

1. A magnetoresistive element comprising
an underlayer,
an anti-ferromagnetic layer,
a first pinned magnetic layer,
a non-magnetic intermediate layer,
a second pinned magnetic layer,
a tunnel barrier layer,
a free magnetic layer, and
a protection layer sequentially laminated,
made by the process of sequentially laminating the layers and smoothing said first pinned magnetic layer before said non-magnetic intermediate layer is laminated over said first pinned magnetic layer.

2. The magnetoresistive element of claim 1, wherein said smoothing process is conducted to provide an average roughness of the center line Ra of 0.3 nm or less.

3. The magnetoresistive element according to claim 1 or 2, wherein said anti-ferromagnetic layer is formed of Ir—Mn alloy.

4. The magnetoresistive element according to claim 3, wherein said tunnel barrier layer is formed of MgO.

5. A method of making a magnetoresistive element, comprising the steps of sequentially laminating an underlayer, an anti-ferromagnetic layer, a first pinned magnetic layer, a non-magnetic intermediate layer, a second pinned magnetic layer, a tunnel barrier layer, a free magnetic layer, and a protection layer, and smoothing said first pinned magnetic layer before lamination of said non-magnetic intermediate layer.

6. The manufacturing method of claim 5, wherein the first pinned magnetic layer is laminated again before lamination of said non-magnetic intermediate layer.

7. The manufacturing method of claim 5 or 6, wherein said smoothing process is conducted by glass cluster ion beam or inverse sputtering method.

8. The manufacturing method of claim 5 or 6, wherein said anti-ferromagnetic layer is formed of Ir—Mn alloy.

9. The manufacturing method of claim 8, wherein said tunnel barrier layer is formed of MgO.

10. A disk drive comprising
a rotating disk medium,
an actuator for moving a read/write element radially across the disk, and
a control system, said read/write element having a magnetoresistive element for reading, the magnetoresistive element including a magnetoresistive element comprising
an underlayer,
an anti-ferromagnetic layer,
a first pinned magnetic layer,
a non-magnetic intermediate layer,
a second pinned magnetic layer,
a tunnel barrier layer,
a free magnetic layer, and
a protection layer sequentially laminated,
made by the process of sequentially laminating the layers and smoothing said first pinned magnetic layer before said non-magnetic intermediate layer is laminated over said first pinned magnetic layer.

11. The disk drive of claim 10, wherein said smoothing process is conducted to provide an average roughness of the center line Ra of 0.3 nm or less.

12. The disk drive of claim 11, wherein said anti-ferromagnetic layer is formed of Ir—Mn alloy.

13. The disk drive of claim 12, wherein said tunnel barrier layer is formed of MgO.
